(19) United States
(12) Patent Application Publication
(10) Pub. No.: US 2025/0299101 A1
(43) Pub. Date: Sep. 25, 2025

(54) MODEL LEARNING APPARATUS, MODEL LEARNING METHOD, AND PROGRAM

(71) Applicant: NEC Corporation, Tokyo (JP)

(72) Inventors: Ryuta MATSUNO, Tokyo (JP); Keita Sakuma, Tokyo (JP); Masakazu Hirokawa, Tokyo (JP)

(73) Assignee: NEC Corporation, Tokyo (JP)

(21) Appl. No.: 19/062,241

(22) Filed: Feb. 25, 2025

(30) Foreign Application Priority Data
Mar. 19, 2024 (JP) 2024-043777

(51) Int. Cl. G06N 20/00

(52) U.S. Cl. CPC G06N 20/00

(57) ABSTRACT

A model learning apparatus of the present disclosure includes: an extracting unit that extracts preset characteristics different from a model prediction error characteristic from a first model generated by machine learning and a second model generated by updating the first model by machine learning; and a learning unit that performs machine learning on the second model by using a loss based on an error between the extracted characteristic of the first model and the extracted characteristic of the second model. Consequently, it is possible to use prediction by a machine learning model for decision making.

### INCORPORATION BY REFERENCE

This application is based upon and claims the benefit of priority from Japanese patent application No. 2024-043777, filed on Mar. 19, 2024, the disclosure of which is incorporated herein in its entirety by reference.

### TECHNICAL FIELD

The present disclosure relates to a model learning apparatus, a model learning method, and a program.

### BACKGROUND ART

A model generated by machine learning can be updated by relearning using new learning data to improve performance in response to environmental changes and so forth. Then, in Patent Literature 1, the precision and compatibility of each model are evaluated using the output of each model before and after the update, that is, a prediction result.
Patent Literature 1: WO2022/185444

However, in the technique disclosed by Patent Literature 1 described above, the compatibility of prediction accuracy in the model before and after the update is only evaluated, and it may occur that the compatibility of the model after the update is lacking with respect to the model before the update. For this reason, a problem arises that it is difficult to maintain compatibility before and after updating the machine learning model.

### SUMMARY OF THE INVENTION

Accordingly, an object of the present disclosure is to provide a model learning apparatus that can solve the abovementioned problem that it is difficult to maintain compatibility before and after updating a machine learning model.

A model learning apparatus as an aspect of the present disclosure includes:
an extracting unit that extracts preset characteristics different from a model prediction error characteristic from a first model generated by machine learning and a second model generated by updating the first model by machine learning; and
a learning unit that performs machine learning on the second model by using a loss based on an error between the extracted characteristic of the first model and the extracted characteristic of the second model.

Further, a model learning method as an aspect of the present disclosure includes:
extracting preset characteristics different from a model prediction error characteristic from a first model generated by machine learning and a second model generated by updating the first model by machine learning; and
performing machine learning on the second model by using a loss based on an error between the extracted characteristic of the first model and the extracted characteristic of the second model.

Further, a program as an aspect of the present disclosure includes instructions for causing a computer to execute processes to:
extract preset characteristics different from a model prediction error characteristic from a first model generated by machine learning and a second model generated by updating the first model by machine learning; and
perform machine learning on the second model by using a loss based on an error between the extracted characteristic of the first model and the extracted characteristic of the second model.

With the configuration as described above, the present disclosure can easily maintain compatibility before and after updating a machine learning model.

### BRIEF DESCRIPTION OF DRAWINGS

FIG. 1 is a block diagram showing a configuration of a model learning apparatus according to the present disclosure;

FIG. 2 is a flowchart showing processing operation of the model learning apparatus according to the present disclosure;

FIG. 3 is a flowchart showing processing operation of the model learning apparatus according to the present disclosure;

FIG. 4 is a block diagram showing a configuration of the model learning apparatus according to the present disclosure; and

FIG. 5 is a block diagram showing a configuration of the model learning apparatus according to the present disclosure.

### EXAMPLE EMBODIMENTS

### First Example Embodiment

A first example embodiment of the present disclosure will be described with reference to the drawings. The drawings may be associated with any of the example embodiments.

### [Configuration]

A model learning apparatus 10 in this example embodiment is used for generating a second model obtained by updating by further machine-learning of a first model generated by machine learning so that the second model is compatible with the first model. At this time, the first model and second model are configured to output a predicted value for predetermined input data as output data.

For example, the first model and second model, which are used in medical setting, use information of a patient as input data and output a predicted value of a later state (medical condition) of the patient as output data. As an example, information of a patient that is input data to be input as an explanatory variable is basic information such as the age and gender of the patient and state information such as the presence or absence of fever, body sluggishness, and the presence or absence of sneezing or coughing, and a predicted value that is output data to be output as an objective variable is a later medical condition or disease name. Consequently, the predict value that is output data by the first model and the second model is referred to by a doctor, and it can be used to assist the doctor's pathological diagnosis, namely, decision making.

As mentioned above, the first model is generated by machine learning in advance using learning data in which the basic information and state information of the past patient, which serve as explanatory variables, and the later medical condition and disease name of the past patient, which serve as objective variables, are paired. Further, as will be described later, the second model is generated by machine learning so as to be compatible with the first model by using update learning data (first data) in which the same explanatory variable and objective variable as described above are paired.

However, the first model and second model may be configured to perform any prediction. That is to say, the learning data learned for generating the first model and the second model may be data including pairs of explanatory variables and objective variables of any content.

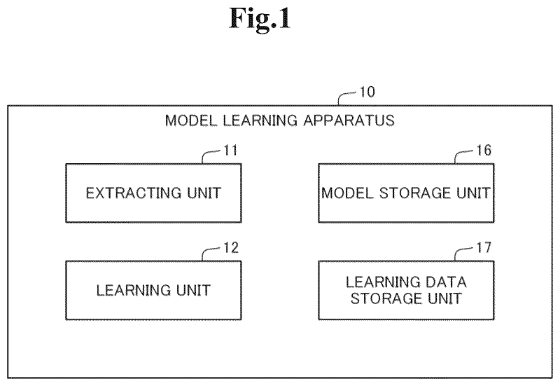

The model learning apparatus 10 in this example embodiment is configured with one or a plurality of information processing apparatuses each including an arithmetic logic unit and a memory unit. Then, the model learning apparatus 10 includes an extracting unit 11 and a learning unit 12 as shown in FIG. 1. The respective functions of the extracting unit 11 and the learning unit 12 can be realized by execution of a program for realizing the respective functions stored in the memory unit by the arithmetic logic unit. Moreover, the model learning apparatus 10 includes a model storage unit 16 and a data storage unit 17. The model storage unit 16 and the data storage unit 17 are configured with the memory unit. The respective components will be described in detail below.

The model storage unit 16 stores the first model generated by executing a machine learning algorithm using prepared learning data. Moreover, the model storage unit 16 stores the second model generated by updating the first model by executing a further machine learning algorithm for the first model using the update learning data, which will be described later.

The data storage unit 17 stores update learning data (first data) including pairs of explanatory variables and objective variables used for machine learning of the second model. The update learning data is obtained by, for example, adding data including pairs of explanatory variables input to the first model at the time of operation of the first model and objective variables corresponding to the explanatory variables, to the learning data used for machine learning of the first model described above. However, the update learning data may not necessarily include the learning data used for machine learning of the first model, and may include only the data used for operation of the first model. Further, the update learning data may not include data used for the operation of the first model, and may be any data.

Further, as will be described later, the data storage unit 17 stores evaluation data (second data) used when extracting the characteristics of the first model and the second model. The evaluation data includes pairs of explanatory variables and objective variables in the same manner as the update learning data described above. Then, the evaluation data may be data of part of the update learning data, may be data including the update learning data in part, or may be data different from the update learning data.

However, the data storage unit 17 is not necessarily limited to storing the evaluation data in advance. For example, the data storage unit 17 may store evaluation data to be later generated by being extracted from the update learning data as will be described later.

The extracting unit 11 extracts a preset type of characteristic from the first model and the second model, respectively. Here, the characteristic of the model extracted by the extracting unit 11 in this example embodiment is at least one of a plurality of types described below. That is to say, the extracting unit 11 may extract one type of characteristic, or may extract two or more types of characteristics, respectively. At this time, the extracting unit 11 may extract a plurality of characteristic values for one type. However, the characteristics of the model to be extracted are not limited to the ones described below.

First, when input data, which is an explanatory variable of evaluation data, is input to the first model and the second model as one type of characteristic, the extracting unit 11 extracts a characteristic when the input data is processed by the first model and the second model, respectively. For example, the extracting unit 11 extracts, as a characteristic, the association degree of each feature value that is each explanatory variable with respect to an objective variable to be output when each explanatory variable is input to the respective models. At this time, the characteristics of the first model and the second model are different from a prediction error characteristic, which is a characteristic related to a prediction error of the model, which will be described later.

To be more specific, an example of a characteristic of each model to be extracted by the extracting unit 11 is the explanatoriness and interpretability of each model. Here, the explanatoriness and interpretability of the model is the description of the content representing which features of the input data have been considered in the output, and can be calculated as the importance and contribution of each feature value to the prediction of the model. Therefore, the extracting unit 11 extracts the importance of each feature value, which is each explanatory variable with respect to the objective variable output when the explanatory variable of the evaluation data is input to each model, as a characteristic. For example, the extracting unit 11 calculates the importance of each feature value in the prediction of each model by using a method such as LIME (local interpretable model-agnostic explanations) and SHAP (SHapley Additive exPlanations). Further, the extracting unit 11 generates a ranking in order of the importance of each feature in each model, extracts the ranking of the importance of the feature value in the first model as a characteristic, and extracts the ranking of the importance of the feature value in the second model as a characteristic. Note that the extracting unit 11 may extract values of a plurality of characteristics in explanatoriness by calculating a ranking of the importance of the feature value for each of the plurality of different evaluation data. However, the extracting unit 11 is not limited to extracting the ranking of the importance of the feature value as a characteristic of the model, and the vector of the importance of the feature value may be used as a characteristic, and a value representing a degree of the importance of the feature value may be used as a characteristic.

Further, another example of the characteristic of each model to be extracted by the extracting unit 11 is the fairness of each model. Here, the model fairness is an index representing the bias of the contribution of a specific feature value to the output of the model. Therefore, the extracting unit 11 extracts, as a characteristic, a fairness index of each feature value that is each explanatory variable for the objective variable to be output when the explanatory variable of the evaluation data is input to each model, respectively. At this time, there are feature values that can contribute to fairness, such as gender and race, as specific feature values that are targeted for calculating the fairness index, that is, as protective feature values. For example, the extracting unit 11 calculates a quantitative evaluation value based on Equalized Odds, Demographic Parity, Equal Opportunity, and the like as a fairness index. Consequently, the extracting unit 11 extracts the fairness index of the specific feature value in the first model as a characteristic, and extracts the fairness index of the specific feature value in the second model as a characteristic. Note that the extracting unit 11 may extract the values of a plurality of characteristics in fairness by calculating the fairness index of a feature value for each of a plurality of different evaluation data.

Further, as another example of the characteristic of each model to be extracted by the extracting unit 11, the extracting unit 11 extracts, as the characteristic, the value of the performance of a computer (information processing apparatus) executing the first model and the second model when the evaluation data is input into the first model and the second model and the first model and the second model are executed. At this time, the first model and second model shall be executed on the same computer, respectively. As an example, the extracting unit 11 extracts, as the characteristic, the value of the performance of the computer, such as the power consumption, memory occupancy, and calculation time of the computer at the time of execution, that is, prediction, of the first model and second model. However, the value of the performance measured as the characteristic from the computer described above is an example, and a value other than the above-described measurement value may be extracted as the characteristic.

A process of extracting the characteristics of the first model and the second model described above by the extracting unit 11 is performed from time to time in a process in which the second model is subjected to machine learning and updated to be described later.

The learning unit 12 generates the second model obtained by updating the first model by machine learning of the update learning data. At this time, the learning unit 12 sets a loss shown in Formula 1 below, and performs machine learning on the second model using the loss.

$$L ( {h}_{2} , {D}_{1} ) + λ \times G ( {h}_{1} , {h}_{2} , {D}_{2} ) \qquad [ Formula 1 ]$$

Here, L (h₂,D₁) in Formula 1 represents a first loss based on a prediction error with respect to update learning data D₁ by a second model h₂ to be updated. That is to say, a first loss L becomes larger as the error between a predicted value that is an output when an explanatory variable of the update learning data D₁ is input into the second model h₂, and an objective variable corresponding to the explanatory variable of the update learning data Dᵢ is larger. As an example, in a case where the second model is a regression model, an average absolute value error or a mean squared error is used for the first loss L, and in a case where the second model is a classification model, an average logarithmic loss, an average hinge loss, or an average 01 loss is used for the first loss L.

Further, G(h₁, h₂,D₂) in Formula 1 represents a second loss based on the characteristics of the first model h₁ and second model h₂ in the evaluation data D₂ extracted as described above. At this time, a second loss G is higher as the compatibility between the characteristic of the first model h₁ and the characteristic of the second model h₂ is lower. That is to say, for each characteristic extracted as described above, an evaluation value representing a degree to which the characteristic of the second model h₂ satisfies the characteristic of the first model h₁ is calculated by comparison between the first model characteristic h₁ of the second model characteristic h₂, and the lower the evaluation value C, the lower the compatibility, and the greater the second loss G. In other words, the second loss G may be made to correspond to, for example, −C(evaluation value), or may be made to correspond to a value that is obtained by subjecting C to a numerical transformation that decreases monotonically as C is increased. Note that λ in Formula 1 is a hyper parameter set by the user.

An example of the second loss G will be described. For example, in a case where the characteristics of the first model h₁ and the second model h₂ are the fairness described above, when an index EqualizedOddsDifference related to EqualizedOdds is used, it can be expressed as the following Formula 2.

$$G ( {h}_{1} , {h}_{2} , {D}_{2} ) = max ( 0 , EqualizedOddsDifference ( {h}_{2} , {D}_{2} ) - EqualizedOddsDifference ( {h}_{1} , {D}_{2} ) ) \qquad [ Formula 2 ]$$

Here, as described above, the second loss G is set according to the evaluation value C of compatibility of the characteristic of the first model h₁ and the characteristic of the second model h₂, but the evaluation value C of compatibility can be calculated in the following manner.

For example, the evaluation value may be calculated in (1,0), such as “evaluation value=1” when the characteristic of the first model satisfies the characteristic of the second model and “evaluation value=0” when not satisfy, and the evaluation value may be calculated as a numerical value of “0.0 to 1.0” according to the degree of satisfaction, and the higher the degree of satisfaction, the higher the value. That is to say, the evaluation value C of compatibility can be calculated to be higher as the compatibility is higher.

Further, as a specific example, in a case where the fairness index of the model described above is extracted as the characteristic of the model, an evaluation value according to whether or not the fairness index value of the second model is equal to or more than the fairness index value of the first model is calculated. At this time, a smaller one of a “value obtained by dividing” the value of the fairness index of the second model by the value of the fairness index of the first model, and “1” is calculated as the evaluation value. That is to say, in a case where the value of the fairness index of the second model is equal to or greater than the value of the fairness index of the first model, “1” is calculated as the evaluation value, and in the other cases, “0” or the “value obtained by dividing” between “0.0 and 1.0” is calculated as the evaluation value. Consequently, in a case where the fairness of the second model is less unfair than that of the first model, the evaluation value becomes large.

Further, as a specific example, in a case where the value of the performance of the computer executing the model described above is extracted as a characteristic of the model, an evaluation value corresponding to whether the value of the performance of the computer at the time of execution of the second model matches the value of the performance of the computer at the time of execution of the first model, or an evaluation value corresponding to the degree of match is calculated. That is to say, “1” is calculated as the evaluation value when they match, and “0” is calculated as the evaluation value when they do not match, or a numerical value of “0.0 to 1.0” is calculated as the evaluation value, which is higher as the degree of match is higher.

In addition, the evaluation value C described above is not limited to being calculated for the compatibility of only one characteristic, and the evaluation values C for a plurality of characteristics may be aggregated to calculate a comprehensive compatibility index (aggregation value) that is one value for evaluating the compatibility of the model. Then, the second loss G described above may be set in accordance with the calculated comprehensive compatibility index. For example, the comprehensive compatibility index is calculated using the following Formula 3.

$$comprehensive compatibility index = \frac{{\sum }_{i = 1}^{n} {w}_{i} {C}_{i}}{{\sum }_{i = 1}^{n} {w}_{i}} \qquad [ Formula 3 ]$$

The above Cᵢ is an evaluation value in the ith characteristic, and is a numerical value indicating a degree to which the characteristic of the second model satisfies the characteristic of the first model. Therefore, Cᵢ is a value of “1” when the characteristic of the second model satisfies the characteristic of the first model, and Cᵢ is a value of “0” or a value of “0.0 to 1.0” representing the degree of satisfaction when not satisfy. In addition, wᵢ is a numerical value representing a weight set for the i^{th} characteristic, for example, a value of “0.0 to 1.0”. As the value of wᵢ, a larger value is set for a characteristic determined to have a larger influence on evaluation of compatibility between the first model and the second model.

In the example of the above Formula 3, the evaluation value is calculated for each of a plurality of characteristics, and a comprehensive compatibility index is calculated from the plurality of evaluation values, but the plurality of characteristics in this case may be a plurality of different types of characteristics, or may be a plurality of characteristics of the same type. For example, the comprehensive compatibility index may be calculated by calculating an evaluation value for each characteristic of a plurality of different types, such as each of explanatoriness and fairness of the model described above. At this time, a plurality of types of characteristics may be combined with any type of characteristics described above. In addition, for example, the comprehensive compatibility index may be calculated by calculating an evaluation value for each characteristic by using the values of a plurality of characteristics in one type such as explanatoriness of the model.

The learning unit 12 performs machine learning on the second model using the update learning data so as to minimize a loss shown in Formula 1 set as described above. Consequently, the second model is subjected to machine learning so that the prediction error is smaller and the compatibility with the first model is higher. Then, the learning unit 12 stores the second model in the model storage unit 16 in which machine learning has been completed by satisfaction of a preset condition, or outputs it to an external source as necessary.

Note that the learning unit 12 is not necessarily limited to using a loss shown in Formula 1 described above at the time of machine learning of the second model. For example, the learning unit 12 may set a loss including at least the second loss G of the losses shown in Formula 1, and perform machine learning on the second model using the update learning data so as to minimize the loss. Consequently, it is possible to generate the second model that has compatibility with the first model.

### [Operation]

Next, the operation of the above-described model learning apparatus 10 will be described. In the model learning apparatus 10, the first model generated in advance, the update learning data, and the evaluation data are stored.

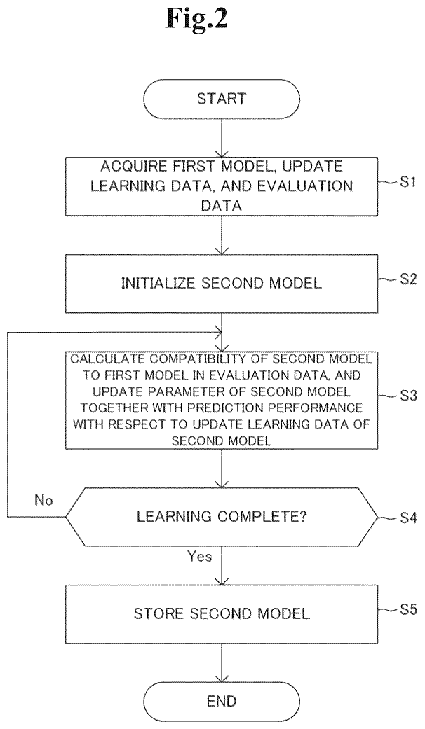

The model learning apparatus 10 acquires the first model, the update learning data, and the evaluation data (step S1 of FIG. 2). Then, the model learning apparatus 10 initializes the second model (step S2 of FIG. 2), and performs machine learning on the second model (step S3 of FIG. 2). Specifically, the model learning apparatus 10 sets a loss including a first loss L based on a prediction error of the second model with respect to the update learning data and a second loss G based on a difference in characteristics, that is, compatibility, between the first model and the second model in the evaluation data as shown in Formula 1, and performs machine learning on the second model using the update learning data so as to minimize the loss. At this time, the characteristics of the model subject to compatibility between the first model and the second model are, for example, explanatoriness and fairness described above, and even the performance of the computer executing the model.

Then, the model learning apparatus 10 performs the above-described machine learning on the second model repeatedly until a preset completion condition is satisfied (step S4 of FIG. 2), and stores or outputs the second model on which machine learning has been completed (step S5 of FIG. 2).

As described above, in the model learning apparatus 10 in this example embodiment, the second model with high compatibility with the first model can be generated because machine learning of the second model is performed using the loss including the second loss G related to the compatibility with the first model. At this time, the machine learning of the second model is performed using the loss including the first loss L related to a prediction error of the second model, so that the second model with high prediction precision can be generated.

### Second Example Embodiment

Next, a second example embodiment of the present disclosure will be described with reference to the drawings. The drawings may be associated with any of the example embodiments.

### [Configuration]

In the model learning apparatus 10 in this example embodiment, the extracting unit 11 has a function of generating the evaluation data (second data). At this time, the extracting unit 11 extracts from the update learning data (first data) stored in the data storage unit 17, and thereby generates the evaluation data by the extracted data.

To be specific, the extracting unit 11 inputs each sample configuring the update learning data into the first model and the second model, respectively, and calculates a prediction error for each sample. Then, the extracting unit 11 extracts, from the samples of the update learning data, a sample that the value of the prediction error is determined to be lower than a preset criterion, that is, a sample determined to have high prediction performance based on the preset criterion, and stores the sample as the evaluation data into the data storage unit 17. For example, evaluation data D₂ in this example embodiment is represented as Formula 4 shown below.

$${D}_{2} = \{ ( x , y ) ∈ {D}_{1} \vert {ℓ}_{1} ( {h}_{1} ( x ) , y ) \leq {τ}_{1} ⋀ {ℓ}_{2} ( {h}_{2} ( x ) , y ) \leq {τ}_{2} \} \qquad [ Formula 4 ]$$

Here, l₁, l₂ are loss functions corresponding to prediction errors of the first model h₁ and the second model h₂, respectively, and τ₁, τ₂ are threshold values for determining whether the prediction performance is high. At this time, the loss functions l₁, l₂ corresponding to the prediction errors are values calculated smaller as the prediction errors are smaller. Therefore, in a case where the values are less than the threshold values τ₁, τ₂, the prediction result is determined to be correct, so that the prediction performance is determined to be high. Consequently, of the samples (x,y) of the update learning data D₁, a sample determined to have high prediction performance in both the first model h₁ and second model h₂ is defined as the evaluation data D2.

Then, the extracting unit 11 extracts the characteristics of the first model and the second model, respectively, in the same manner as described above by using the evaluation data D₂ extracted from the update learning data D₁. The extraction of the evaluation data D₂ described above by the extracting unit 11 and the extraction of the characteristics of the first model and the second model are performed as needed in a process in which the second model is subjected to machine learning and updated.

The learning unit 12 sets a loss as shown in Formula 1 in the same manner as described above, and performs machine learning on the second model using the update learning data. That is to say, in this example embodiment, the second loss G related to compatibility of the characteristics of the models included in the loss shown in Formula 1 is set by focusing on the evaluation data D2 including samples (x,y) determined to have high prediction performance in both the first model h₁ and second model h₂. That is to say, in the first model and the second model, the second model with high compatibility with the first model is generated for samples (x,y) with high prediction performance in which the prediction result is correct. This is because compatibility is not emphasized for samples with low prediction performance in which the prediction result is incorrect.

Here, a specific example of the second loss G in this example embodiment is shown in Formula 5. In this example, the characteristics of the first model h₁ and second model h₂ are the explanatoriness described above, which are the importance of the respective feature values.

$$G ( {h}_{1} , {h}_{2} , {D}_{2} ) = \frac{1}{\vert {D}_{2} \vert} {\sum }_{( x y ) ∈ {D}_{2}} A ( E ( {h}_{1} , x ) , E ( {h}_{2} , x ) ) \qquad [ Formula 5 ]$$

Here, E(h,x) is a function that calculates the importance of explanatoriness, that is, the feature value, which is a characteristic for the explanatory variable x of the model h, and A(E(h₁,x),E(h₂,x)) is a loss function related to the compatibility of explanatoriness, which is the characteristic of the first model h₁ and second model h₂. In this example, the simple average of the losses related to compatibility between the models in the respective samples is the second loss G. However, the second loss G may be set in any method, such as being a weighted average of the losses related to compatibility between the models in the respective samples.

Here, the loss function represented by A(E(h₁,x), E(h₂,x)) described above may be expressed in terms of the degree of matching such as the distance of importance of the feature values representing explanatoriness as shown in Formula 6 below as an example. Further, the loss function may be expressed in terms of the matching degree in the importance of the top k feature values or the matching degree between the rankings of importance of the top k feature values, and may be expressed in any method.

$$A ( E ( {h}_{1} , x ) , E ( {h}_{2} , x ) ) = {‖ E ( {h}_{1} , x ) - E ( {h}_{2} , x ) ‖}_{2} \qquad [ Formula 6 ]$$

### [Operation]

Next, the operation of the above-described model learning apparatus 10 will be described. In the model learning apparatus 10, the first model generated in advance and the update learning data are stored.

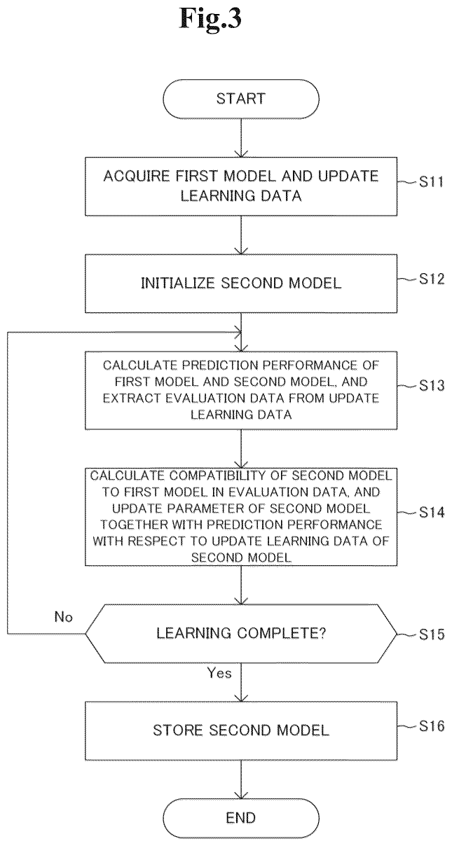

The model learning apparatus 10 acquires the first model and the update learning data (step S11 of FIG. 3). Then, the model learning apparatus 10 initializes the second model (step S12 of FIG. 3), and extracts the evaluation data from the update learning data (step S13 of FIG. 3). To be specific, the model learning apparatus 10 inputs each sample configuring the update learning data into the first model and the second model, respectively, and extracts a sample determined to have high prediction performance as the evaluation data.

Then, the model learning apparatus 10 performs machine learning on the second model in the same manner as described above by using the extracted evaluation data (step S14 of FIG. 3). Specifically, the model learning apparatus 10 sets a loss including a first loss L based on a prediction error of the second model with respect to the update learning data and a second loss G based on a difference in characteristics, that is, compatibility, between the first model and the second model in the evaluation data as shown in Formula 1, and performs machine learning on the second model using the update learning data so as to minimize the loss.

Then, the model learning apparatus 10 performs extraction of the evaluation data and machine learning of the second model described above repeatedly until a preset completion condition is satisfied (step S15 of FIG. 3), and stores or outputs the second model on which machine learning has been completed (step S16 of FIG. 3).

As described above, in the model learning apparatus 10 in this example embodiment, the machine learning of the second model is performed using the loss including the second loss G related to compatibility with the first model focusing on samples with high prediction performance by the first model and the second model. Thus, it is possible to generate the second model with high compatibility with the first model.

### Third Example Embodiment

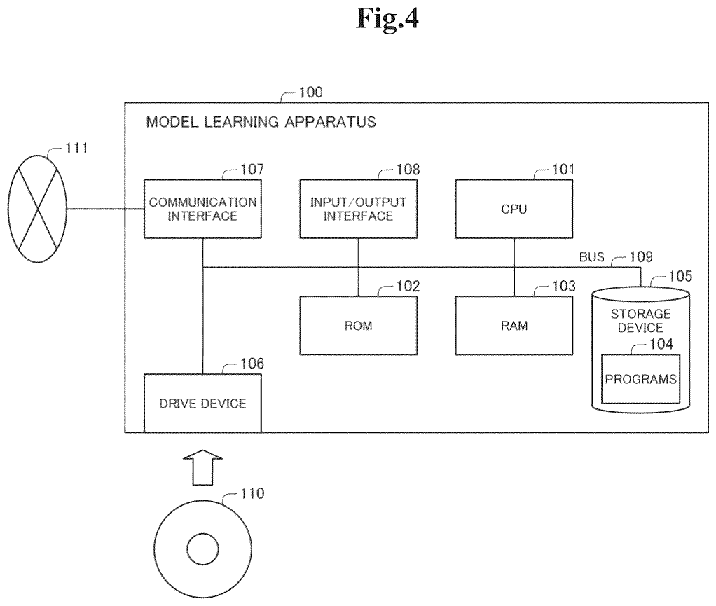

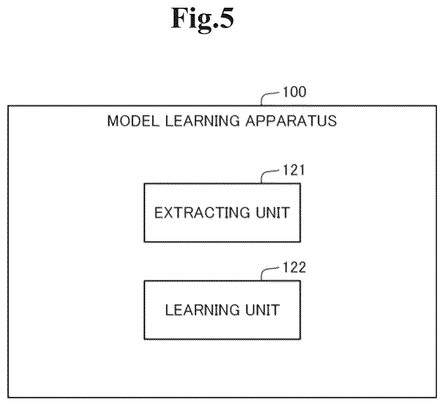

Next, a third example embodiment of the present disclosure will be described with reference to the drawings. This example embodiment shows the overview of a configuration of the model learning apparatus described in the above example embodiments. FIGS. 4 to 5 are diagrams for describing the configuration, and the drawings may be associated with any of the example embodiments.

First, a hardware configuration of a model learning apparatus 100 will be described with reference to FIG. 4 The model learning apparatus 100 is configured with a general information processing apparatus and, as an example, has the following hardware configuration including: a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 4 shows an example of the hardware configuration of the information processing apparatus serving as the model learning apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

Then, the model learning apparatus 100 can construct and include an extracting unit 121 and a learning unit 122 shown in FIG. 5 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the extracting unit 121 and the learning unit 122 described above may be constructed using dedicated electronic circuits for realizing such means.

The extracting unit 121 extracts preset characteristics different from a prediction error characteristic of a model from a first model generated by machine learning and a second model generated by updating the first model by machine learning. The learning unit 122 performs machine learning on the second model by using a loss based on an error between the extracted characteristic of the first model and the extracted characteristic of the second model.

With the configuration as described above, the present disclosure can generate the second model that is highly compatible with the first model because machine learning of the second model is performed using a loss based on an error in characteristic from the first model.

Note that at least one or more functions of the functions of the extracting unit 121 and the learning unit 122 described above may be performed by an information processing apparatus installed and connected anywhere on the network, that is, may be performed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. Then, each of the example embodiments described above can be combined with the other example embodiment as necessary.

### SUPPLEMENTARY NOTES

The whole or part of the example embodiments disclosed above can be described as the following supplementary notes. Hereinafter, the overview of the configurations of a model learning apparatus, a model learning method, and a program in the present disclosure will be described. However, the present disclosure is not limited to the following configurations.

### Supplementary Note 1

A model learning apparatus comprising:
at least one memory storing processing instructions; and
at least one processor configured to execute the processing instructions to:
extract preset characteristics different from a model prediction error characteristic from a first model generated by machine learning and a second model generated by updating the first model by machine learning; and
perform machine learning on the second model by using a loss based on an error between the extracted characteristic of the first model and the extracted characteristic of the second model.

### Supplementary Note 2

The model learning apparatus according to Supplementary Note 1, wherein the at least one processor is configured to execute the processing instructions to perform machine learning on the second model by using a first loss based on a prediction error by the second model and a second loss based on an error between the characteristic of the first model and the characteristic of the second model.

### Supplementary Note 3

The model learning apparatus according to Supplementary Note 2, wherein the at least one processor is configured to execute the processing instructions to perform machine learning on the second model by using the first loss based on a prediction error by the second model with respect to preset first data and the second loss based on an error between the characteristic of the first model and the characteristic of the second model with respect to preset second data.

### Supplementary Note 4

The model learning apparatus according to Supplementary Note 3, wherein the at least one processor is configured to execute the processing instructions to extract the second data from the first data based on a prediction performance by each of the first model and the second model with respect to the first data.

### Supplementary Note 5

The model learning apparatus according to Supplementary Note 4, wherein the at least one processor is configured to execute the processing instructions to extract, as the second data, the first data that the prediction performance by each of the first model and the second model with respect to the first data is determined to be high based on a preset criterion.

### Supplementary Note 6

The model learning apparatus according to Supplementary Note 1, wherein the at least one processor is configured to execute the processing instructions to extract, as the characteristic, an association degree of a variable included in input data with respect to output data that is output from each of the first model and the second model when the input data is input.

### Supplementary Note 7

The model learning apparatus according to Supplementary Note 1, wherein the at least one processor is configured to execute the processing instructions to extract, as the characteristic, a value of a performance measured from a computer executing the first model and the second model when input data is input.

### Supplementary Note 8

8. A model learning method comprising:
extracting preset characteristics different from a model prediction error characteristic from a first model generated by machine learning and a second model generated by updating the first model by machine learning; and
performing machine learning on the second model by using a loss based on an error between the extracted characteristic of the first model and the extracted characteristic of the second model.

### Supplementary Note 9

The model learning method according to Supplementary Note 8, comprising
performing machine learning on the second model by using a first loss based on a prediction error by the second model and a second loss based on an error between the characteristic of the first model and the characteristic of the second model.

### Supplementary Note 10

The model learning method according to Supplementary Note 9, comprising
performing machine learning on the second model by using the first loss based on a prediction error by the second model with respect to preset first data and the second loss based on an error between the characteristic of the first model and the characteristic of the second model with respect to preset second data.

### Supplementary Note 11

The model learning method according to Supplementary Note 10, comprising
extracting the second data from the first data based on a prediction performance by each of the first model and the second model with respect to the first data.

### Supplementary Note 12

The model learning method according to Supplementary Note 11, comprising
extracting, as the second data, the first data that the prediction performance by each of the first model and the second model with respect to the first data is determined to be high based on a preset criterion.

### Supplementary Note 13

The model learning method according to Supplementary Note 8, comprising
extracting, as the characteristic, an association degree of a variable included in input data with respect to output data that is output from each of the first model and the second model when the input data is input.

### Supplementary Note 14

The model learning method according to Supplementary Note 8, comprising
extracting, as the characteristic, a value of a performance measured from a computer executing the first model and the second model when input data is input.

### Supplementary Note 15

A non-transitory computer-readable storage medium comprising instructions for causing a computer to execute processes to:
extract preset characteristics different from a model prediction error characteristic from a first model generated by machine learning and a second model generated by updating the first model by machine learning; and
perform machine learning on the second model by using a loss based on an error between the extracted characteristic of the first model and the extracted characteristic of the second model.

### DESCRIPTION OF REFERENCE NUMERALS

10 model learning apparatus
11 extracting unit
12 learning unit
16 model storage unit
17 data storage unit
100 model learning apparatus
101 CPU
102 ROM
103 RAM
104 programs
105 storage device
106 drive device
107 communication interface
108 input/output interface
109 bus
110 storage medium
111 communication network
121 extracting unit
122 learning unit

1. A model learning apparatus comprising:
at least one memory storing processing instructions; and
at least one processor configured to execute the processing instructions to:
extract preset characteristics different from a model prediction error characteristic from a first model generated by machine learning and a second model generated by updating the first model by machine learning; and
perform machine learning on the second model by using a loss based on an error between the extracted characteristic of the first model and the extracted characteristic of the second model.

2. The model learning apparatus according to claim 1, wherein the at least one processor is configured to execute the processing instructions to
perform machine learning on the second model by using a first loss based on a prediction error by the second model and a second loss based on an error between the characteristic of the first model and the characteristic of the second model.

3. The model learning apparatus according to claim 2, wherein the at least one processor is configured to execute the processing instructions to
perform machine learning on the second model by using the first loss based on a prediction error by the second model with respect to preset first data and the second loss based on an error between the characteristic of the first model and the characteristic of the second model with respect to preset second data.

4. The model learning apparatus according to claim 3, wherein the at least one processor is configured to execute the processing instructions to
extract the second data from the first data based on a prediction performance by each of the first model and the second model with respect to the first data.

5. The model learning apparatus according to claim 4, wherein the at least one processor is configured to execute the processing instructions to
extract, as the second data, the first data that the prediction performance by each of the first model and the second model with respect to the first data is determined to be high based on a preset criterion.

6. The model learning apparatus according to claim 1, wherein the at least one processor is configured to execute the processing instructions to
extract, as the characteristic, an association degree of a variable included in input data with respect to output data that is output from each of the first model and the second model when the input data is input.

7. The model learning apparatus according to claim 1, wherein the at least one processor is configured to execute the processing instructions to
extract, as the characteristic, a value of a performance measured from a computer executing the first model and the second model when input data is input.

8. A model learning method comprising:
extracting preset characteristics different from a model prediction error characteristic from a first model generated by machine learning and a second model generated by updating the first model by machine learning; and
performing machine learning on the second model by using a loss based on an error between the extracted characteristic of the first model and the extracted characteristic of the second model.

9. The model learning method according to claim 8, comprising
performing machine learning on the second model by using a first loss based on a prediction error by the second model and a second loss based on an error between the characteristic of the first model and the characteristic of the second model.

10. The model learning method according to claim 9, comprising
performing machine learning on the second model by using the first loss based on a prediction error by the second model with respect to preset first data and the second loss based on an error between the characteristic of the first model and the characteristic of the second model with respect to preset second data.

11. The model learning method according to claim 10, comprising
extracting the second data from the first data based on a prediction performance by each of the first model and the second model with respect to the first data.

12. The model learning method according to claim 11, comprising
extracting, as the second data, the first data that the prediction performance by each of the first model and the second model with respect to the first data is determined to be high based on a preset criterion.

13. The model learning method according to claim 8, comprising
extracting, as the characteristic, an association degree of a variable included in input data with respect to output data that is output from each of the first model and the second model when the input data is input.

14. The model learning method according to claim 8, comprising
extracting, as the characteristic, a value of a performance measured from a computer executing the first model and the second model when input data is input.

15. A non-transitory computer-readable storage medium comprising instructions for causing a computer to execute processes to:
extract preset characteristics different from a model prediction error characteristic from a first model generated by machine learning and a second model generated by updating the first model by machine learning; and
perform machine learning on the second model by using a loss based on an error between the extracted characteristic of the first model and the extracted characteristic of the second model.
